(19) United States
(12) Patent Application Publication
(10) Pub. No.: US 2008/0270816 A1
(43) Pub. Date: Oct. 30, 2008

(54) Portable data storage apparatus and synchronization method for the same

(75) Inventor: Chin-Ling Wang, Hsin-Chu Hsien (TW)

Correspondence Address: BACON & THOMAS, PLLC, 625 SLATERS LANE, FOURTH FLOOR, ALEXANDRIA, VA, 22314-1176, US

(73) Assignee: Phison Electronics Corp., Hsin-Chu Hsien (TW)

(21) Appl. No.: 11/790,318

(22) Filed: Apr. 25, 2007

(51) Int. Cl. G06F 1/12

(52) U.S. Cl. 713/400

(57) ABSTRACT

The present invention discloses a portable data storage apparatus for use with a host device, including an interface coupled to the host device for data transmission therebetween, a real time clock (RTC) for synchronizing the portable data storage apparatus with a clock time, and a memory module for storing data and a detection program for detecting time discrepancy between system time of the host device and the clock time of the RTC after the storage apparatus is loaded to the host device.

### FIELD OF THE INVENTION

The present invention relates to a data storage apparatus and a synchronization method, and more particularly, to a portable data storage apparatus with a real time clock (RTC) and a synchronization method for use with a host device.

### BACKGROUND OF THE INVENTION

A real time clock (RTC) is a time registering device keeping the track of time in industrial applications such as memory devices, varying from camera, cellular phone, personal digital assistant (PDA), and the like. These memory devices need accurate clock time for synchronization purposes, inclusive of assigning a sequence order for a multi-event transaction so that if a failure occurs the transaction can be cancelled, or recording time in relation to a particular starting point. All too often, the RTC loses track of time due to partial or total loss of the power source. A battery utilized to power the RTC may provide inadequate power levels because it is worn out or subjected to temperatures beyond its operation range. Under circumstances such as memory re-programming operation, RTC might lose its time accuracy as well. If incorrect RTC time is relied on, incorrect measurements are likely to result. For example, a cardiograph having a RTC is meant for continual observation and recordation of the electric currents associated with contractions of the heart periodically. It is rather problematic if the RTC encounters unpredictable errors and consequently loses its track of time. Hence, there is a resulting need for a method and apparatus to keep the RTC ticking on the right track.

FIG. 1 is a flowchart showing a method for maintaining the real time clock of the flash device according to U.S. Pat. No. 6,167,482. The method includes installing a software RTC service routine running outside the affected flash memory device, as shown in step 100, wherein a counter (timer) software routine measures the total re-programming procedure duration. The software RTC service routine, running inside the affected flash memory device is stopped, as any read operation from the flash will return the flash status register content and not the flash storage content, as in step 102. The current absolute unit time is saved in a read/write accessible memory cell, as shown in step 104 and a re-programming cycle executed, as in step 106. The previously running application is initiated, as shown in step 108, and the unit's timing set to the previously stored value, as in step 110. In this context, an application may include firmware code, whereby the application may be required to reload firmware in order to update versions or to load firmware capable of running in an environment other than the current environment or infrastructure. The software RTC service routine running inside the re-programmed flash device is then re-started, as in step 112. Subsequently, when appropriate, the software RTC service routine running outside the re-programmed flash is stopped, as shown in step 114, and the measured total programming duration to the current RTC value, as in step 116. The application then continues as shown in step 118. In this manner, there is automatic maintenance of the real-time clock.

As discussed above, the U.S. Pat. No. 6,167,482 simply employs a counter and software to calculate and infer when the RTC starts losing track of time after every re-programming session to maintain accurate time-keeping. However, the accuracy of a conventional real time clock degrades more or less due to poor stability and temperature characteristics of typical RTC. It is desirable to have a method and apparatus to mitigate the problems mentioned above that prior art methods fail to.

The primary focus of the present invention is to introduce a storage apparatus and a synchronization method utilizing an auto-run detection program capable of synchronizing the storage apparatus whenever loaded to a host device, such as a computer. As an alternative, the clock time of the storage apparatus and the system time of the host device can be synchronized altogether when connected to the Internet. Unlike conventional storage apparatuses, such as that of U.S. Pat. No. 6,167,482, the present invention significantly mitigates the problems of prior arts as well as keeps data well-managed in a time sequence order.

### SUMMARY OF THE INVENTION

Certain problems of previous devices have been recognized by the present invention. It has been noted that previous devices did not take advantage of the benefits which have been found to be possible according to the present invention. It is an object of the present invention to provide a portable storage apparatus for better data management.

In accordance with an aspect of the present invention, a portable data storage apparatus for use with a host device includes an interface coupled to the host device for data transmission therebetween, a real time clock (RTC) for synchronizing the portable data storage apparatus with a clock time, and a memory module for storing data and an detection program capable of synchronizing the clock time of the RTC with a system time of the host device after the storage apparatus is loaded to the host device.

Alternatively, the portable data storage apparatus further includes a controller for controlling operation of the data storage apparatus.

Preferably, the data storage apparatus further includes a battery module for supplying electrical power.

Certainly, the auto-run detection program updates the clock time of the RTC with the system time of the host device after the data storage apparatus is loaded to the host device.

Certainly, the auto-run detection program updates the clock time of the RTC with the system time of the host device only when the time discrepancy detected exceeds a predetermined time tolerance.

Preferably, the predetermined time tolerance ranges from 1 minute to 24 hours.

Preferably, the predetermined time tolerance is around 5 minutes.

Preferably, the detection program updates the clock time of the RTC with an Internet time retrieved from the Internet via the host device.

Typically, the RTC includes at least one register for storing updated time from the host device via the controller.

Typically, the auto-run detection program is stored in the host device after the data storage apparatus is loaded to the host device.

Alternatively, the interface includes a Universal Serial Bus (USB) interface, an Institute of Electrical and Electronics Engineers 1394 (IEEE 1394) interface, an external Serial Advanced Technology Attachment (eSATA) interface, and an Ultra Wideband (UWB) interface.

Alternatively, the memory module encompasses a flash memory, a Hard Disk Drive (HDD), a Compact Disc Rewritable (CD-RW), a Digital Video Disc Rewriteable (DVD-RW), a Secure Digital (SD) card, a Multi-media Card (MMC), a Micro SD card, a Compact Flash (CF) card, a Memory Stick (MS) card, a MS Due card, a MS Pro card, a MS Micro (M2) card, a Smart Media (SM) card, and a MMC Micro card.

Alternatively, the host device comprises a computer, a Personal Digital Assistant (PDA), and a Portable Media Player (PMP).

In accordance with another aspect of the present invention, a synchronization method for a portable data storage apparatus with a clock time having an auto-run detection program for communication with a host device with a system time, comprises the steps of: a) loading the auto-run detection program to the host device; b) detecting time discrepancy between the clock time of the data storage apparatus and the system time of the host device; c) determining if the time discrepancy exceeds a predetermined time tolerance; and d) updating clock time of the data storage apparatus with the system time when the time discrepancy exceeds a predetermined time tolerance.

Typically, the synchronization method further comprises a step of detecting presence of the data storage apparatus on the host device.

Preferably, the updating step includes a step of storing the system time in a memory module of the data storage apparatus.

Preferably, the predetermined time tolerance ranges from 1 minute to 24 hours.

Preferably, the predetermined time tolerance is around 5 minutes.

Preferably, the synchronization method further comprises a step of retrieving an Internet clock time and updating the system time of the host device when the host device is connected to the Internet.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a flowchart of maintaining the real time clock of the flash device according to the prior art;

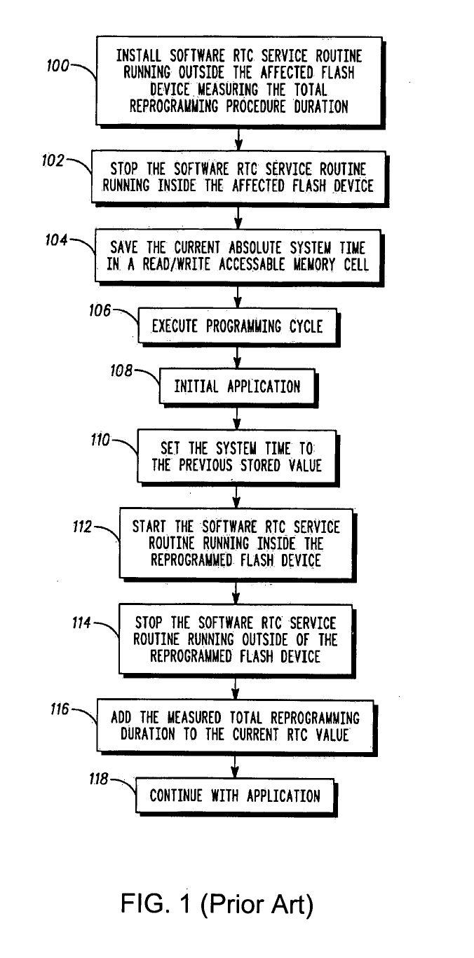

FIG. 2 is a block diagram of a data storage apparatus according to a preferred embodiment of the present invention;

FIG. 3 illustrates steps of a synchronization method according to a preferred embodiment of the present invention;

FIGS. 4(a)-4(d) are schematic diagrams of SCSI commands and SCSI data according to the present invention;

FIG. 5 is a register map of the RTC according to the present invention;

FIG. 6 is a schematic diagram of the RTC according to the present invention;

FIG. 7 illustrates a data transfer overview according to the present invention; and

FIGS. 8(a)-8(b) illustrate data transfer activity on a bus according to the present invention.

### DETAILED DESCRIPTION OF THE PREFERRED EMBODIMENTS

The present invention discloses a portable data storage apparatus and a synchronization method for application in the same. The objects and advantages of the present invention will become more readily apparent to those ordinarily skilled in the art after reviewing the following detailed description. The present invention needs not be limited to the following embodiments.

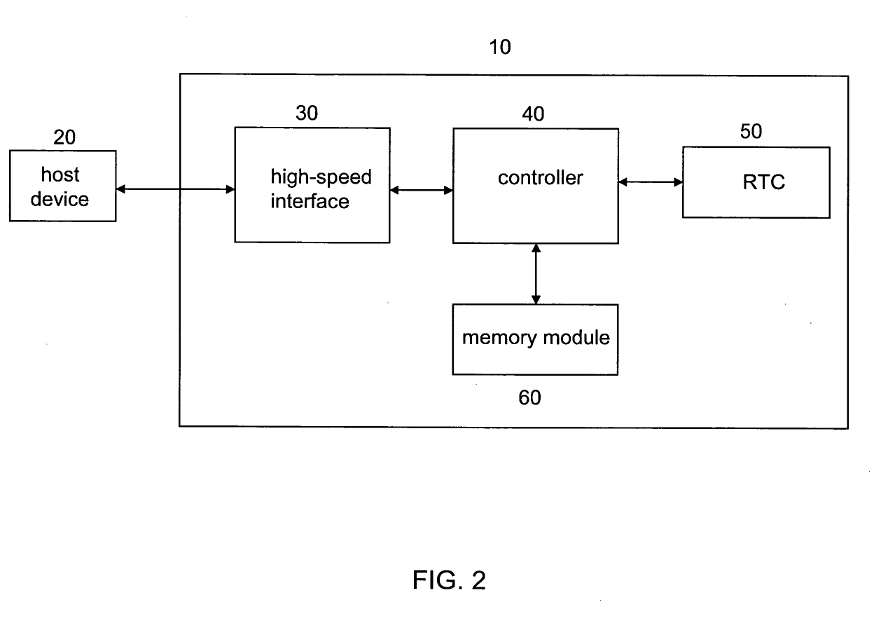

Please refer to FIG. 2. It illustrates an architecture of a portable data storage apparatus according to the present invention. As shown in FIG. 2, the data storage apparatus 10 is loaded to a host device 20, such as a computer, via a high-speed interface 30 of Universal Serial Bus (USB) for data buffering and commands transporting therebetween. To implement this invention, alternate embodiments could employ other host devices, such as a Personal Digital Assistant (PDA), a Portable Media Player (PMP), or a portable device with information display function. In addition to the high-speed interface 30, the data storage apparatus 10 includes a controller 40 for controlling reading from and writing to a real time clock (RTC) 50, a memory module 60 having a file allocation table (FAT) for storing data entries each indexing read/write time of its corresponding data, and a battery module (not shown) as an electrical power source. In particular, the controller 40 works as a central intermediate for communication and manipulation between the data storage apparatus 10 and the host device 20.

The RTC 50 has one or more registers (not shown) stored with time data for synchronizing the storage apparatus 10 and keeping a clock time. Likewise, the host device 20 keeps a system time for synchronization purpose. The memory module 60 is provided for storing data and an auto-run detection program for detecting time discrepancy between the clock time of the storage apparatus 10 and the system time of the host device 20. The auto-run detection program executes automatically after loaded to the host device 20. Typically, the storage apparatus 10 allows a predetermined time tolerance ranging from 1 minute to 24 hours, subject to modification of manufacturers. The auto-run detection program is configured to synchronize the clock time of the RTC 50 with the system time of the host device 20 if the detected time discrepancy exceeds the predetermined time tolerance, around 5 minutes in this embodiment. In other words, if the time discrepancy is less than 5 minutes, the RTC 50 remains its current clock time; otherwise the RTC 50 will synchronize its clock time with the system time of the host device 20. Besides, the detection program synchronizes the clock time of the RTC 50 with the system time of the host device 20 right after the data storage apparatus 10 is loaded to the host device 20. Alternatively, when the host device 20 is connected to the Internet, the detection program is capable of reading the accurate time with reference to a clock locatable on the Internet and synchronizing the system time of the host device 20 along with the clock time of the RTC 50 accordingly by means of Network Time Protocol (NTP).

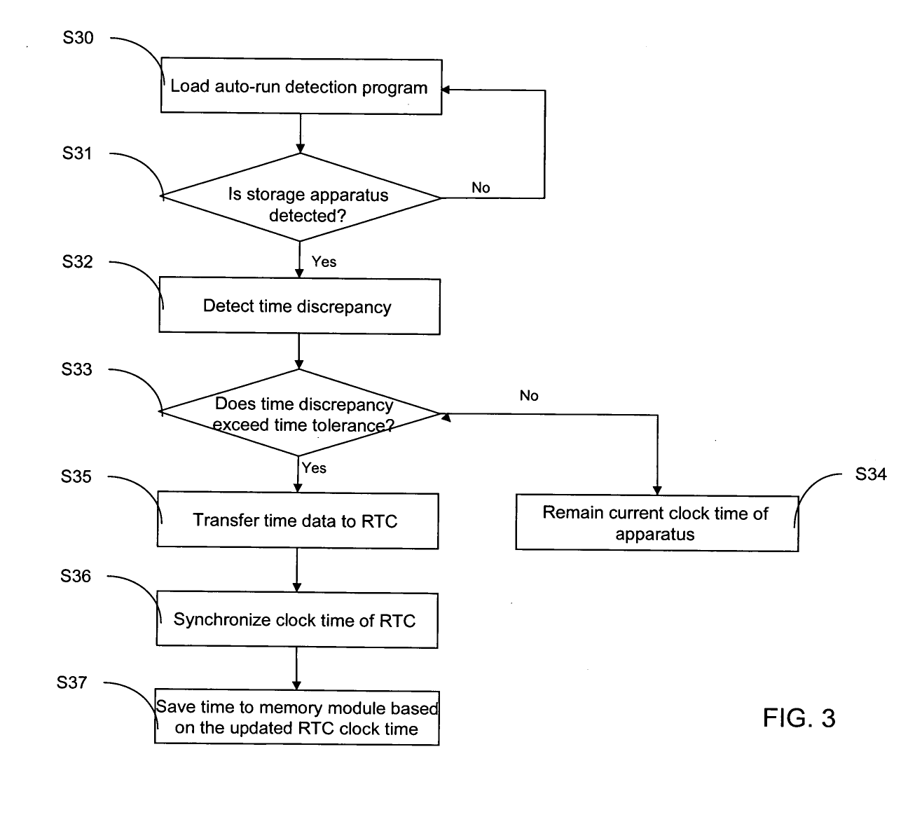

Referring now to FIG. 3, it illustrates a preferred embodiment of implementing a synchronization method according to the present invention. The method begins with step S30 that the auto-run detection program is loaded to the host device 20. The presence of the storage apparatus 10 will be detected if the auto-run detection program is successfully loaded; otherwise step S31 will return to step S30 to reload the program. As shown in steps S32 to S33 of FIG. 3, the program functions to detect the time discrepancy somewhat existing between the clock time of the storage apparatus 10 and the system time of the host device 20, and further determine if the time discrepancy exceeds the predetermined time tolerance of 5 minutes. In alternate embodiments, the predetermined time tolerance could be either minimized to 1 minute, or maximized to 24 hours. If the time discrepancy detected is less than 5 minutes, step S33 will proceed to step S34 by remaining the current clock time of the storage apparatus. Or else, step S35 will be taken if the detected time discrepancy exceeds the predetermined time tolerance of 5 minutes. For example, the clock time of the storage apparatus 10 is 17 minutes behind the system time of the host device 20, step S35 will be taken. Subsequently, the controller 40 signals the host device 20 to send time data to the storage apparatus 10 for setting the RTC 50 through the high-speed interface 30.

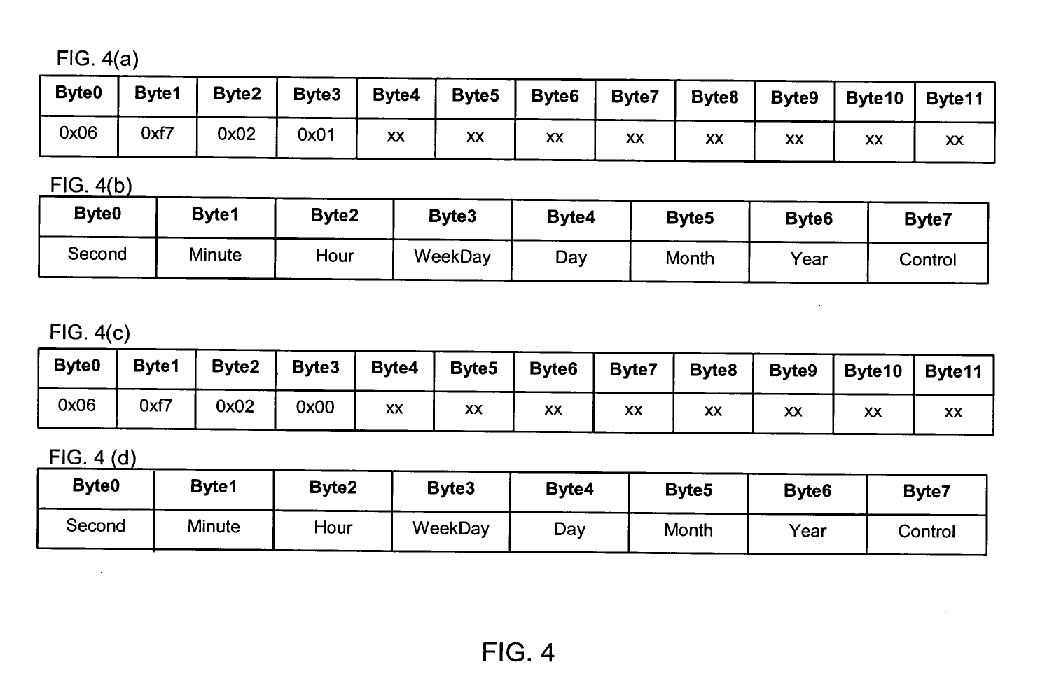

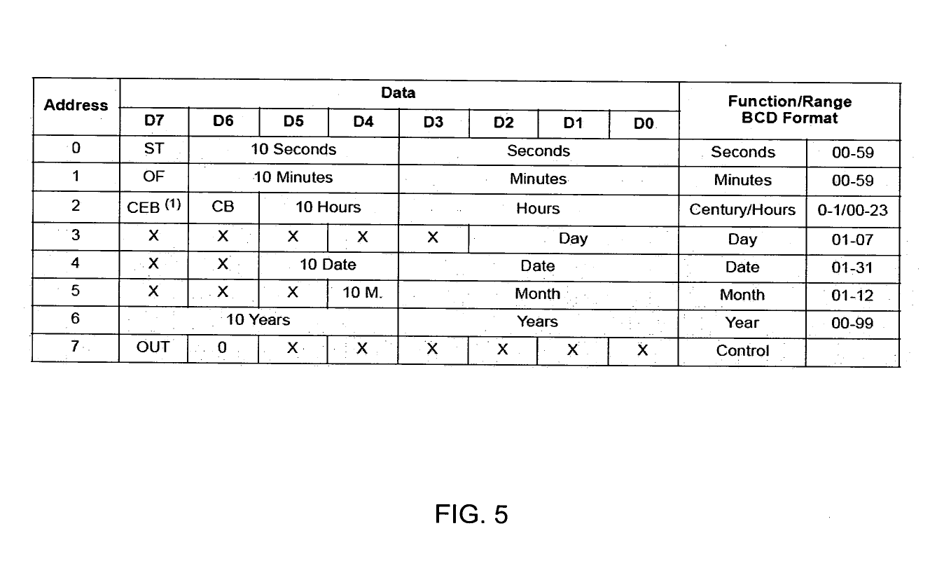

Please refer to FIG. 3 to FIG. 5. By transporting from the host device 20 a Small Computer System Interface (SCSI) command, i.e. a command block wrapper (CBW), as shown in FIG. 4(a), the clock time kept by the storage apparatus 10 can be synchronized with the system time of the host device 20 at step S36 of FIG. 3. The time data sent from the host device 20, known as SCSI data-out (DO) in FIG. 4(b), is mapped to the register (as shown in FIG. 5) of the RTC 50 through the controller 40 for setting the clock time. The last step S37 of FIG. 3, is performed by storing updated clock time data of the RTC 50 in the memory module 60. For better results, the synchronization method could be further devised by incorporating the Internet. When the host device 20 is connected to the Internet, the clock time of the apparatus 10 and the system time of the host device 20 can be synchronized altogether with the standard current time retrieved from the Internet by means of NTP. After the synchronization, the host device 20 reads the time data, known as SCSI data-in (DI) in FIG. 4(d), from the RTC 50 through the controller 40 by transporting a CBW as shown in FIG. 4(c). Typically, the DI and DO can be mapped into the RTC register. The time data transfer is to be expatiated in the follow-up descriptions.

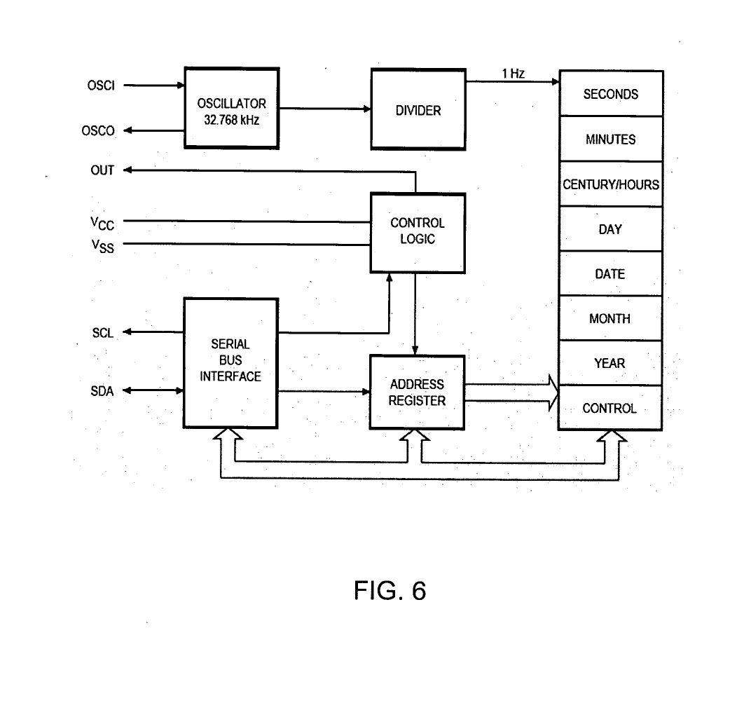

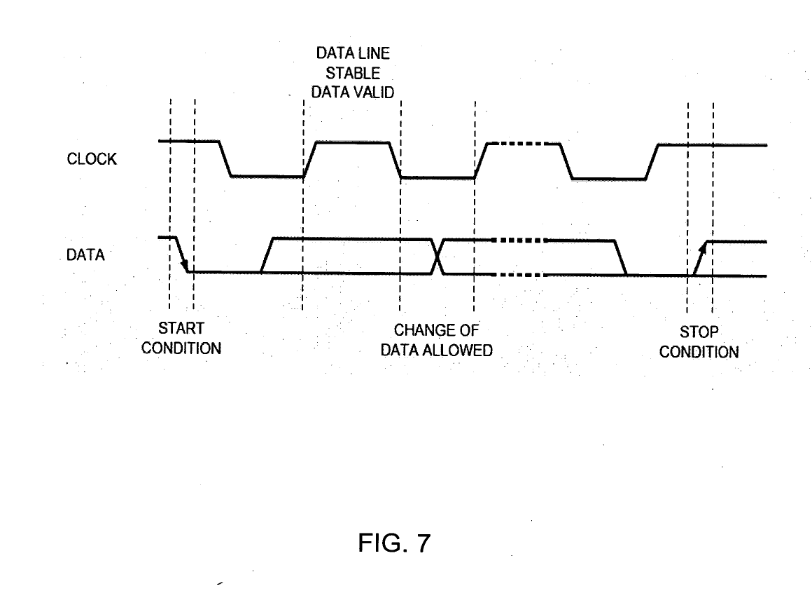

The architecture of a typical RTC is well-known as illustrated in FIG. 6. The RTC 50 is coupled to the controller 40 through the serial bus interface as indicated in FIG. 6 (hereinafter referring to as the “bus”) for data transferring. Referring now to FIG. 7, it is an overview of data transfer sequence. The controller 40 acts as a master device to control the RTC 50, defined as a slave device in this embodiment. Connections between the master and the slave device are made on the bus through the SCL input and open-drain serial data (SDA) I/O lines, as indicated in FIG. 6. The controller 40 generates serial clock (SCL), the START and STOP conditions, and controls the bus access. As shown in FIG. 7, a change in the state of the data line from high to low, while the clock line is high, defines a START condition. On the contrary, a change in the state of the data line from low to high, while the clock line is high, defines a STOP condition. Besides, the state of the data line represents DATA VALID when, after a START condition, the data line is stable for the duration of the high period of the clock signal. The data on the line must be changed during the low period of the clock signal. Certainly, each data transfer is initiated with a START condition and terminated with a STOP condition.

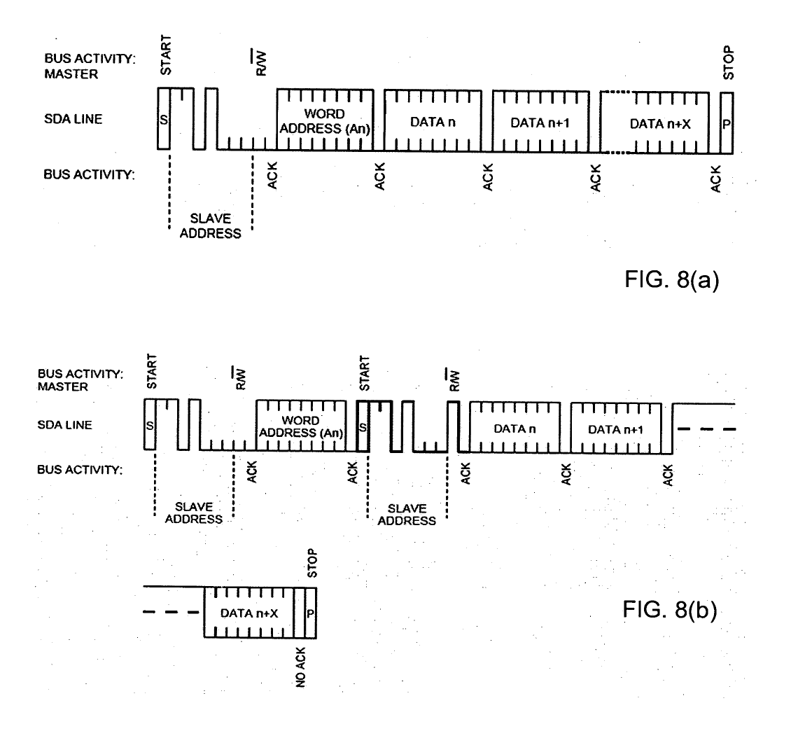

FIG. 8 details how time data transfer, including reading and writing, is accomplished on the bus. According to the present invention, there are two types of data transfer, namely writing and reading, as shown in FIG. 8(a) and FIG. 8(b) respectively. Typically, START and STOP are recognized as the beginning and end of a serial transfer. As for the writing operation to the RTC 50 shown in FIG. 8(a), serial data and clock are received through SDA and SCL. The first byte transmitted by the controller 40 is the slave address, and then follows a number of data bytes. After each byte is received, an acknowledge bit “ACK” is returned by the RTC 50. The slave address is followed by a direction bit “R/W”, which is “0” for a write. After receiving and decoding the slave address byte, the RTC 50 outputs an acknowledge bit “ACK” on SDA line. Meanwhile, the controller 40 may terminate the data writing transfer by generating a STOP condition.

The difference between the reading from and writing to the RTC 50 primarily lies in the state of the direction bit R/W. Literally, the data transfer direction in the reading operation is reversed, in contrast with the writing operation. The direction bit R/W is “0” for a write as mentioned above, while the direction bit R/W is “1” for a read. In addition, the RTC 50 must receive a “not acknowledge” to terminate a read, namely the last data byte is followed by a not acknowledge “NO ACK” signal, as indicated in FIG. 8(b).

In conclusion, the present invention discloses a portable data storage apparatus equipped with an auto-run detection program and a synchronization method to meet the time-keeping requirements of memory devices, suchlike assigning a sequence order for each data to differentiate one from the other for better data management. In the execution of various embodiments, either connected to the computer or the Internet, the data storage apparatus is capable of tuning up to the most current clock time automatically, while the conventional apparatus requires manual set-up whenever losing track of time. The present invention ensures that transitory data stored in a memory remains synchronized, and eliminates the prior potential deficiencies. Such precision makes it easier for memory device applications and their users to manage data in a time sequence manner.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A portable data storage apparatus for use with a host device, comprising:
an interface coupled to the host device for data transmission therebetween;
a real time clock (RTC) for synchronizing the portable data storage apparatus with a clock time; and
a memory module for storing data and a detection program for updating the clock time of the RTC with a system time of the host device after the storage apparatus is loaded to the host device.

2. The data storage apparatus according to claim 1, further comprising a controller for controlling operation of the data storage apparatus.

3. The data storage apparatus according to claim 1, further comprising a battery module for supplying electrical power.

4. The data storage apparatus according to claim 1, wherein the detection program updates instantly the clock time of the RTC with the system time of the host device right after the data storage apparatus is loaded to the host device.

5. The data storage apparatus according to claim 1, wherein the detection program updates the clock time of the RTC with the system time of the host device only when the time discrepancy detected exceeds a predetermined time tolerance.

6. The data storage apparatus according to claim 5, wherein the predetermined time tolerance ranges from 1 minute to 24 hours.

7. The data storage apparatus according to claim 1, wherein the detection program updates the clock time of the RTC with an Internet clock time retrieved from Internet via the host device.

8. The data storage apparatus according to claim 2, wherein the RTC comprises at least one register for storing updated time from the host device via the controller.

9. The data storage apparatus according to claim 1, wherein the detection program is automatically stored in the host device after the data storage apparatus is loaded to the host device.

10. The data storage apparatus according to claim 1, wherein the interface comprises a Universal Serial Bus (USB) interface, an Institute of Electrical and Electronics Engineers 1394 (IEEE 1394) interface, an external Serial Advanced Technology Attachment (eSATA) interface, and an Ultra Wideband (UWB) interface.

11. The data storage apparatus according to claim 1, wherein the memory module comprises a flash memory, a Hard Disk Drive (HDD), a Compact Disc Rewritable (CD-RW), a Digital Video Disc Rewriteable (DVD-RW), a Secure Digital (SD) card, a Multi-media Card (MMC), a Micro SD card, a Compact Flash (CF) card, a Memory Stick (MS) card, a MS Due card, a MS Pro card, a MS Micro (M2) card, a Smart Media (SM) card, and a MMC Micro card.

12. The data storage apparatus according to claim 1, wherein the host device comprises a computer, a Personal Digital Assistant (PDA), and a Portable Media Player (PMP).

13. In a portable data storage apparatus with a clock time having a detection program for communication with a host device with a system time, a time synchronization method comprising the steps of:
loading the detection program to the host device;
detecting time discrepancy between the clock time of the data storage apparatus and the system time of the host device;
determining if the time discrepancy exceeds a predetermined time tolerance; and
updating clock time of the data storage apparatus with the system time when the time discrepancy exceeds a predetermined time tolerance.

14. The method according to claim 13, further comprising step of detecting presence of the data storage apparatus on the host device.

15. The method according to claim 13, further comprising a step of storing updated clock time in a memory module of the data storage apparatus.

16. The method according to claim 13, wherein the predetermined time tolerance ranges from 1 minute to 24 hours.

17. The method according to claim 16, wherein the predetermined time tolerance is around 5 minutes.

18. The method according to claim 13, further comprising a step of retrieving an Internet clock time for updating the system time of the host device when the host device is connected to the Internet.

19. In a USB portable data storage apparatus with a clock time having a detection program stored in a NAND flash memory thereof for communication with a host device having a system time, a time synchronization method comprising the steps of:
executing the detection program on the host device when the data storage apparatus is connected to the host device; and
updating the clock time of the data storage apparatus with the system time of the host device.

20. The method according to claim 19, wherein the detection program is executed automatically on the host device when the data storage apparatus is connected to the host device.

21. The method according to claim 19, further comprising a step of retrieving Internet clock time and updating the system time of the host device when the host device is connected to the Internet.
